(19) United States
(12) Patent Application Publication
(10) Pub. No.: US 2022/0275910 A1
(43) Pub. Date: Sep. 1, 2022

(54) PIPE LEADTHROUGH MODULE FOR A CRYOGENIC CONTAINER

(71) Applicant: Cryoshelter GmbH, Dobl-Zwaring (AT)

(72) Inventor: Matthias REBERNIK, Dobl-Zwaring (AT)

(21) Appl. No.: 17/634,793

(22) PCT Filed: Aug. 12, 2020
(86) PCT No.: PCT/AT2020/060302

§ 371 Date: Feb. 11, 2022

(30) Foreign Application Priority Data
Aug. 14, 2019 (AT) GM501542019

(51) Int. Cl. F17C 3/08

(52) U.S. Cl. CPC F17C 3/08; F17C 2223/0161; F17C 2203/0391; F17C 2205/0355; F17C 2221/033; F17C 2265/066; F17C 2270/0168; F17C 2201/056; F17C 2203/0629; F17C 2205/0358; F17C 2205/0361; F17C 2205/0364; F17C 2209/221; F17C 2260/033

(57) ABSTRACT

The invention relates to a pipe penetration module (7) for a cryogenic container (1), which comprises an inner tank (2) and an outer container (3) vacuum-insulated relative to said inner tank, the pipe penetration module (7) comprising a cladding pipe (6) and a pipeline (5) at least partially accommodated in the cladding pipe (6), wherein the pipeline (5) passes with a first pipeline end (10) through a first cladding pipe end (8) of the cladding pipe (6) so that the first pipeline end (10) can be rigidly connected to the outer container (3) and the first cladding pipe end (8) can be rigidly connected to the inner tank (2), the pipeline (5) and the cladding pipe (6) being rigidly connected to one another at a second cladding pipe end (13), and with the pipeline (5) and the cladding pipe (6) each having a kink (17, 18) in an area between the first cladding pipe end (8) and the second cladding pipe end (13).

The invention relates to a pipe penetration module for a cryogenic container, which comprises an inner tank and an outer container vacuum-insulated relative to said inner tank, the pipe penetration module comprising a cladding pipe and a pipeline at least partially accommodated in the cladding pipe.

According to the prior art, liquefied gases can be stored in containers (“cryogenic containers”) in order to store them as a fuel for an engine, for example. Liquefied gases are gases which exist in the liquid state at boiling temperature, the boiling temperature of this fluid being pressure-dependent. If such a cryogenic liquid is filled into a cryogenic container, a pressure corresponding to the boiling temperature will arise, aside from thermal interactions with the cryogenic container itself.

Since the fluid stored in the cryogenic container is at a temperature which is significantly lower than the ambient temperature of the cryogenic container, the latter must be designed accordingly in order to reduce any heat transmissions that occur. For this purpose, it is known from the prior art to design cryogenic containers as double-walled tanks which comprise an inner tank and an outer container. The inner tank is thus accommodated in the outer container and is thermally insulated therefrom, for example, by means of a vacuum which is provided between the inner tank and the outer container.

In such embodiments, it should be noted, in particular, that thermal changes in length of the inner tank and the outer container that occur in different operating states of the container must be compensated for. Operational stability is therefore desired despite the mechanical changes in length and vibrations during operation.

In this context, pipeline routings between the inner tank and the outer container are particularly critical, for example, in order to fill the inner tank or to remove fluid from the inner tank. Due to the thermal changes in length, the pipeline routings must therefore be configured so as to allow the inner tank and the outer container to be telescoped into one another.

For pipe penetrations with a passage in the area of the cylinder jacket of the cryogenic container, the assembly of the inner tank can also be enabled with the pipe penetrations into the outer container that have already been installed, i.e., the projection beyond the cylinder jacket of the inner tank can be selected to be smaller than the inner diameter of the outer container, at least at the time of assembly.

It is therefore an object of the invention to create a pipe penetration module which can absorb thermal changes in length of the inner tank and the outer container particularly well.

This object is achieved by a pipe penetration module for a cryogenic container, which comprises an inner tank and an outer container vacuum-insulated relative to said inner tank, the pipe penetration module comprising a cladding pipe and a pipeline at least partially accommodated in the cladding pipe, wherein the pipeline can be passed through a first cladding pipe end of the cladding pipe so that the first pipeline end can be rigidly connected to the outer container and the first cladding pipe end can be rigidly connected to the inner tank, the cladding pipe and the pipeline being rigidly connected to one another at a second cladding pipe end, with the cladding pipe and the pipeline each having a kink in an area between the first and the second end of the cladding pipe.

As a result of the kink in the pipeline within the cladding pipe, the pipeline is allowed to have more leeway within the cladding pipe in the event of thermal changes in length than is the case with linear pipe penetration modules. Thermal changes in length of the inner tank and the outer container can therefore be effectively compensated for with the present pipe penetration module. Furthermore, the kink allows the pipeline to be pulled out more from the cladding pipe, e.g., by at least one wall thickness of the outer container, in order to simplify welding to the pipeline with the outer container.

Due to the kink in the cladding pipe and the pipeline, vibrations in the outer container can also be offset better so that they are not transmitted to the inner tank. Furthermore, the connection of the cladding pipe to the inner tank or, respectively, of the pipeline to the outer container can be established easily and can be implemented, for example, by an automatable welding seam.

A further advantage of the solution according to the invention is that a reinforcement of the inner tank is not required so that small diameters of the connecting pieces can be achieved, as a result of which the cryogenic container can be manufactured in compliance with guidelines. Last but not least, the kink achieves a flexible structure of the compensating module, whereby tolerance compensation is achieved for all individual, component and assembly tolerances encountered during assembly.

It is advantageous if the kinks are configured in such a way that a first section of the cladding pipe or, respectively, the pipeline is at an angle of 30° to 150°, preferably of 70° to 110°, particularly preferably of 90°, relative to a second section of the cladding pipe or, respectively, the pipeline. It is indeed preferred if the kink amounts to 90°, since the structure of the compensating module is thus considerably simplified, however, kink angles deviating therefrom are also possible so as to achieve the advantages that have been explained above.

It is particularly preferred if the pipeline or the cladding pipe is more flexible across at least one functional section than outside of the functional section. As a result, an improved equalization of thermal changes in length can be achieved through a favourable distribution of mechanical stresses. If the functional section is provided on the pipeline, the functional section is preferably located at least partially within the cladding pipe. This can be realized in particular by the following embodiments.

According to one embodiment, it is preferred if the pipeline has a thinner wall thickness across at least one functional section than outside of the functional section, with the functional section being located at least partially within the cladding pipe. As an alternative to this, the pipeline can be designed as a bellows pipe across at least one functional section, with the functional section being located at least partially within the cladding pipe. Depending on the embodiment, the functional section can also be located entirely within the cladding pipe.

Both of the aforementioned embodiments have the advantage that, due to the thinning of the pipeline wall thickness or, respectively, because of the design as a bellows pipe, a more improved equalization of thermal changes in length is achieved through a favourable distribution of mechanical stresses. Furthermore, it may be achieved through the above-mentioned measures that the concentration of increased mechanical stresses on the end areas of the pipeline, where the cladding pipe is connected to the inner tank (both at the first cladding pipe end and—optionally—at the second cladding pipe end) and the pipeline is connected to the outer container, is avoided.

In further embodiments, it may also be envisaged that the cladding pipe has a thinner wall thickness across at least one functional section than outside of the functional section, or the cladding pipe is designed as a bellows pipe across at least one functional section. In such embodiments, it is particularly preferred if an axial reinforcement is spanned across the functional section. For example, two stiffening rods running in parallel to the cladding pipe and located on opposite sides of the cladding pipe can be used as the axial reinforcement. On the one hand, radial buckling or, respectively, bending of the cladding pipe between the stiffening rods is thereby permitted, and, on the other hand, the cladding pipe is continually prevented from being compressed in the axial direction.

In order to facilitate the attachment of the pipe penetration module to the cryogenic container, it can be envisaged that the pipeline has a welding sleeve at the first pipeline end for connection to the outer container and/or the cladding pipe has a stiffening ring at the first cladding pipe end for connection to the inner tank. In this way, the individual components can be connected in particular with automated welding seams, since the welding sleeve and, respectively, the stiffening ring are particularly well suited for those purposes.

Furthermore, it is preferred if the cladding pipe has an end plate at the second cladding pipe end for connection to the inner tank. As a result, the cladding pipe can be advantageously connected to the inner tank also at the second cladding pipe end, whereby the cladding pipe can be rigidly connected to the inner tank at both ends. The purpose of this is that it is more difficult for vibrations in the pipeline to set the cladding pipe into a resonance vibration.

In a further embodiment, the pipeline can be equipped with an internal thread at the first pipeline end. As a result, it becomes possible that the pipeline end can be pulled out of the pipe penetration module in a simplified manner, as a result of which a weld connection with the outer container can subsequently be produced with greater ease.

In the assembled state, the invention consequently relates to a cryogenic container comprising an inner tank, an outer container that is vacuum-insulated relative to the inner tank, and a pipe penetration module according to any of the above-mentioned embodiments, with the cladding pipe protruding into the inner tank. On the one hand, the pipeline protrudes into the inner tank, but, on the other hand, it also protrudes out of the inner tank, where it is connected to the outer container.

In a particularly preferred embodiment, the pipe penetration module is connected to the cryogenic container in such a way that the pipe penetration module functions as a thermal siphon when the cryogenic container is in an operating position. According to the invention, the kink therefore not only has the function of equalizing thermal changes in length, but, in addition, makes it possible to avoid thermal bridges between the inner tank and the outer container due to the siphon effect. This is achieved in that the evaporation of the liquid phase leads to the formation of a gas cushion at the warm end of the conduit, which gas cushion cannot return into the inner tank, whereby the liquid phase is prevented from flowing further. The heat input can therefore be reduced to an acceptable level. The concrete installation position of the pipe penetration module for achieving the effect as a thermal siphon is at the discretion of the person skilled in the art.

Advantageous and non-limiting embodiments of the invention are explained in further detail below with reference to the drawings.

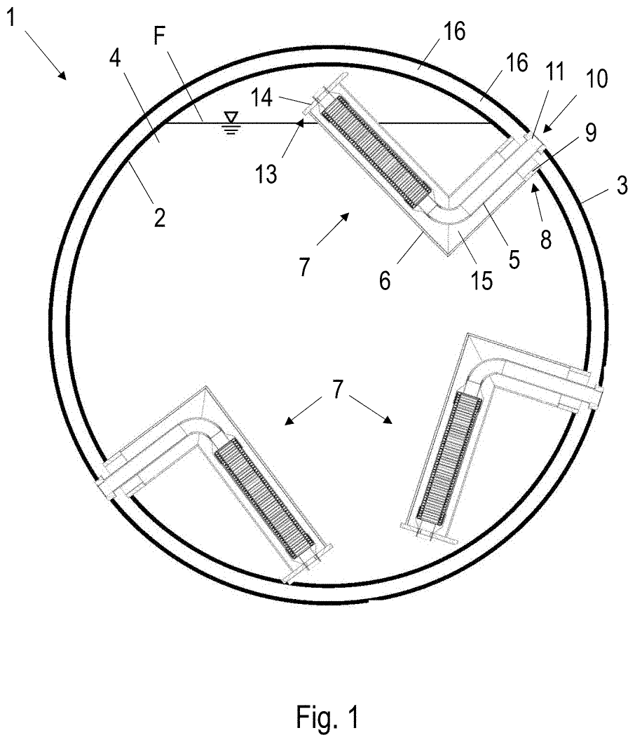

FIG. 1 shows a cryogenic container with three pipe penetration modules according to the invention.

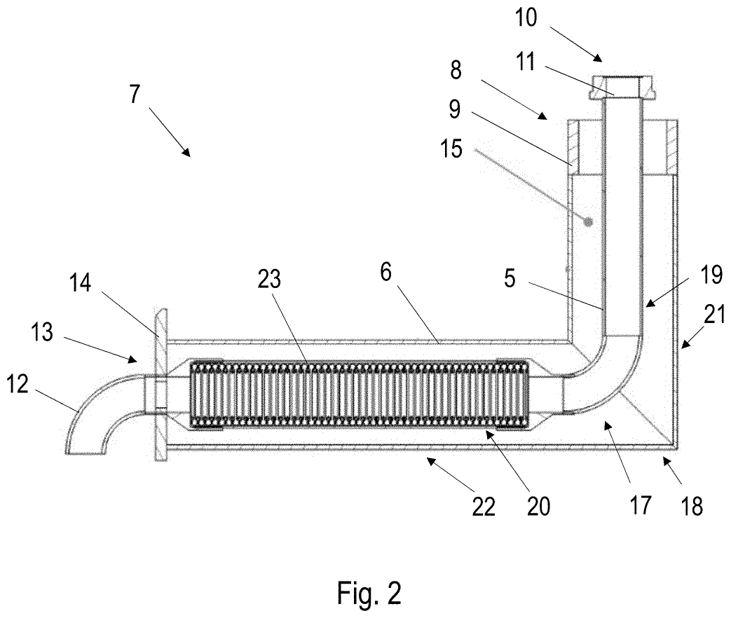

FIG. 2 shows one of the pipe penetration modules of FIG. 1 in detail.

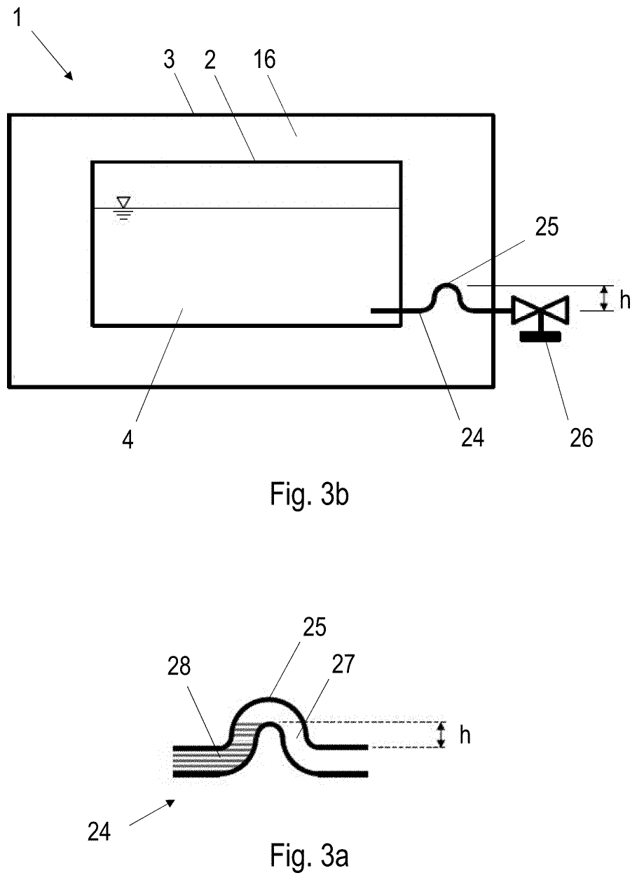

FIG. 3a shows a cryogenic container with a thermal siphon according to the prior art, and FIG. 3b shows a detail of FIG. 3a.

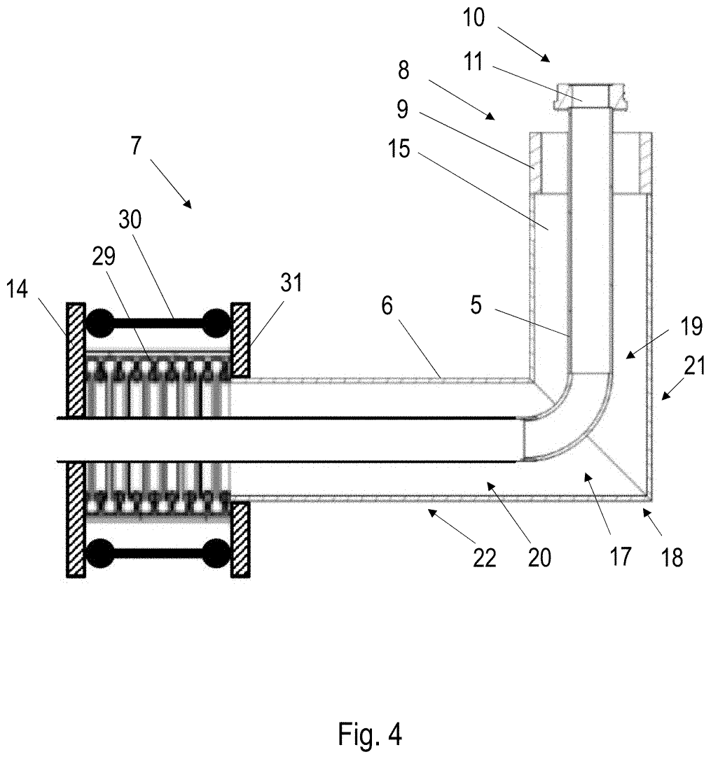

FIG. 4 shows an alternative embodiment of the pipe penetration module of FIG. 2.

FIG. 1 shows a cryogenic container 1 which comprises an inner tank 2 and an outer container 3 vacuum-insulated relative to said inner tank. The fluid 4 stored in the cryogenic container 1 is, for example, liquefied natural gas, also known to those skilled in the art as LNG (“Liquid Natural Gas”). In the illustrated example, the fluid 4 is in liquid form up to a fill level F, beyond that, it is in the gaseous state. The cryogenic container 1 is usually carried on a motor vehicle, in which case the fluid 4 serves as fuel for an engine of the motor vehicle.

In order to introduce fluid 4 into the cryogenic container 1 or to remove fluid 4 therefrom, a pipeline 5 is provided between the inner tank 2 and the outer container 3. However, a rigid connection of the pipeline 5 to both the inner tank 2 and the outer container 3 would have the effect that thermal changes in length of the inner tank 2 relative to the outer container 3 would severely impair this connection. For this reason, the pipeline 5 is configured together with a cladding pipe 6 as a pipe penetration module 7, which will be described in detail below.

According to FIG. 1, three pipe penetration modules 7 are provided in the cryogenic container 1. The pipe penetration module 7 arranged at the top in the installation position is used as a filling line, and the two pipe penetration modules 7 arranged at the bottom in the installation position are used as liquid extraction lines. However, the pipe penetration module 7 is not limited to those exemplary embodiments, but can also be used, for example, as a heat exchanger supply line or a heat exchanger discharge line.

The pipe penetration module 7 is formed in that the pipeline 5 is accommodated in the cladding pipe 6 at least partially. The cladding pipe 6 protrudes completely into the inner tank 2 and is rigidly connected, e.g., welded, to the inner tank 2 at a first cladding pipe end 8. As illustrated in FIG. 2, the cladding pipe 6 has a stiffening ring 9 at the first cladding pipe end 8, which facilitates welding of the cladding pipe 6 to the inner tank 2. The stiffening ring 9 can also be formed by thickening the cladding pipe 6 so that the attachment of a separate stiffening ring 9 can be omitted.

Furthermore, it is evident from FIG. 1 that the pipeline 5 is rigidly connected, e.g., welded, to the outer container 3 at a first pipeline end 10. As illustrated in FIG. 2, the pipeline 5 has a welding sleeve 11 at the first pipeline end 10, which facilitates welding of the pipeline 5 to the outer container 3. Furthermore, the first pipeline end 10 can preferably be equipped with an internal thread for being pulled out of the cladding pipe 6 more easily for a welding process to the outer container 3. Part of the pipeline 5 is guided between the outer container 3 and the inner tank 2, and the remaining part protrudes into the inner tank 2, where it is accommodated in the cladding pipe 6.

The pipeline 5 has a second pipeline end 12 within the inner tank 2, and the cladding pipe 6 has a second cladding pipe end 13. The pipeline 5 and the cladding pipe 6 are rigidly connected to one another at the second cladding pipe end 13, for which purpose the cladding pipe 6 may have an end plate 14 in this area. The second pipeline end 12 can open out either into the end plate 14 or outside of it if the pipeline 5 is passed through the end plate 14.

The pipeline 5 and the cladding pipe 6 are spaced apart from one another within the pipe penetration module 7 so that a spacing area 15 is provided between them. In this spacing area 15, a vacuum exists just like in the intermediate space 16 between the inner tank 2 and the outer container 3 in order to achieve thermal insulation. The spacing area 15 is connected to said intermediate space 16, for example. Alternatively, the cladding pipe 6 could also comprise a plate at the first cladding pipe end, which plate ends with the pipeline 5 so that the spacing area 15 is sealed off from the intermediate space 16.

According to the invention, the pipeline 5 and the cladding pipe 6 each have a kink 17, 18 in an area between the first and the second cladding pipe end 8, 13. The pipeline 5 can thus have a first section 19, the kink 17 and a second section 20, and the cladding pipe 6 can have a first section 21, the kink 18 and a second section 22. The first section 19 of the pipeline 5, which has the welding sleeve 11 and is connected to the outer container 3, and the first section 21 of the cladding pipe 6, which has the stiffening ring 9 and is connected to the inner tank 2, are arranged essentially coaxially. This also includes deviations that occur as part of thermal changes in length and deviations as a result of manufacturing tolerances, which can be caused, on the one hand, by the pipe penetration itself and, on the other hand, also by the container, the inner tank suspension, pressure vessel bottoms, etc. The second section 20 of the pipeline 5 and the second section 22 of the cladding pipe 6, which each are interconnected, are also arranged essentially coaxially, apart from deviations that occur due to thermal changes in length as well as manufacturing tolerances.

The kink 17 in the pipeline 5 can be implemented, for example, by a bent section of the pipeline 5 so that the pipeline 5 can continue to be manufactured in one piece. Alternatively, the first section 19, the kink 17 and the second section 20 of the pipeline 5 could be manufactured separately and could be connected, e.g., welded, to one another. Those two embodiments can also be applied for the first section 21, the kink 18 and the second section 22 of the cladding pipe 6.

The kinks 17, 18 can be configured in such a way that the first sections 19, 21 of the pipeline 5 or, respectively, the cladding pipe 6 are at an angle of 30° to 150°, preferably of 70° to 110°, particularly preferably of 90°, relative to a second section 20, 22 of the pipeline 5 or, respectively, the cladding pipe 6. In the example illustrated in FIGS. 1 and 2, the kinks 17, 18 form an angle of 90°.

Furthermore, FIGS. 1 and 2 show that the pipeline 5 has a functional section 23 located within the cladding pipe 6. As shown, the pipeline 5 is designed as a bellows pipe, in particular a metal bellows pipe, across the functional section 23, which aids the pipeline 5 with the deformation as a result of thermal changes in length by reducing the stresses that occur in the process. As an alternative to this, the pipeline 5 can be provided with a wall thickness across the functional section 23 that is thinner than the wall thickness of the pipeline 5 outside of the functional section 23. The thinner wall thickness can also be accomplished by a wall thickness gradient. Several functional sections 23 within the cladding pipe 6 each with identical or different qualities can also be provided. Moreover, the bellows pipe, the metal bellows pipe or, respectively, the thin wall thickness can each be provided with a braided weave so that the ability of the pipeline 5 to absorb high internal pressures can be improved.

FIG. 3a shows how a thermal siphon is formed according to the prior art. In the intermediate space 16 between the inner tank 2 and the outer container 3 of a cryogenic tank 1, a pipeline 24 with an elevation 25 of the height h is provided. If fluid flows through this pipeline and the valve 26 is then closed, fluid is initially present in the entire pipeline 24 in the liquid state. As shown in FIG. 3b, a gas bubble 27 forms in the pipeline 24 due to the temperature at the outer container 3 that is increased in relation to the fluid, which gas bubble is held close to the outer container 3 by the elevation 25. The gas bubble 27, in combination with the elevation 25, prevents the liquid phase 28 from flowing further in the direction of the outer container 3, as a result of which the gas bubble 27 can contribute to the thermal insulation of the fluid 4 relative to the outer container 3, or, respectively, a constant afterflow and evaporation of the liquid phase and the associated heat input into the inner tank can be prevented.

With the pipe penetration module 7, a thermal siphon is simultaneously achieved for an improved thermal change in length, without a complicated structure having to be provided in the process, as in the prior art, with a specially provided elevation 25 in the intermediate space 16.

According to the invention, the pipe penetration module 7 is incorporated to this end into the cryogenic container 1 with the kink 17, 18 already present in such a way that the pipe penetration module 7 functions as a thermal siphon when the cryogenic container 1 is in an operating position. For example, this can be achieved in that the first pipe section 19 connected to the outer container 6 exhibits a negative slope relative to the horizontal, starting from its connection point to the outer container 3. Alternatively, the first pipe section 19 connected to the outer container 6 can exhibit a positive slope relative to the horizontal, starting from its connection point to the outer container 3, so that the kink 17 is located above the connection point of the pipeline 5 to the outer container 6. In this case, however, the second pipeline end 12 should lead to below the connection point of the pipeline 5 to the outer container 6. The axis of the pipeline 5 does not have to lie in a normal plane of the container, but can also run obliquely thereto.

As a further alternative, the pipe penetration module 7 could also be installed in a different position, for example, if the pipe penetration module completely or partially projects above a nominal fill level F. In principle, a person skilled in the art can easily determine a suitable installation position for the pipe penetration module 7 so that the pipe penetration module 7 will function as a thermal siphon.

Thus, through suitable positioning, one and the same pipe penetration module 7 can be attached to the entire circumference of the inner container, regardless of the purpose of the pipe penetration module 7, whereby the pipe penetration module 7 can, in each case, be used as a thermal siphon.

FIG. 4 shows an alternative embodiment of the pipe penetration module 7 of FIG. 2, with like reference symbols indicating like elements. In this embodiment, the pipeline 5 does not have a functional section 23, but the cladding pipe 6 comprises a functional section 29. Said functional section 29 can also be designed as a bellows pipe, as has been shown. Alternatively, the cladding pipe 6 could have a thinner wall thickness across the functional section 29 than outside of the cladding pipe 6. In both embodiments, the cladding pipe 6 can have an axial reinforcement 30 spanning the functional section 29. For example, two stiffening rods running in parallel to the cladding pipe 6 and located on opposite sides of the cladding pipe 6 can be used for this purpose. The stiffening rods can, for example, be welded, on the one hand, to the end plate 14 and, on the other hand, to an intermediate plate 31, which in turn is attached to the flexurally rigid part of the cladding pipe 6. The reinforcement 30 is to be configured in such a way that it prevents the cladding pipe 6 from being compressed in the axial direction and permits bending or, respectively, buckling in a radial direction.

Irrespective of whether the functional section 23, 29 is provided on the pipeline 5 or on the cladding pipe 6, the pipeline 5 or, respectively, the cladding pipe 6 is designed so as to be more flexible across the functional section 23, 29 than outside of the functional section 23, 29, which, as already explained, can be achieved, for example, by a bellows pipe or a thinner wall thickness. Due to the flexibility of the functional section 23, 29, the pipe penetration module 7 can absorb bending stresses with greater ease.

Depending on the embodiment, the pipeline 5 or the cladding pipe 6 can have one or several functional sections 23, 29. In addition, both the pipeline 5 and the cladding pipe 6 can have one or several functional sections 23, 29.

1.-14. (canceled)

15. A cryogenic container comprising an inner tank, an outer container vacuum-insulated relative to the inner tank, and a pipe penetration module for the cryogenic container, the pipe penetration module comprising a cladding pipe and a pipeline at least partially accommodated in the cladding pipe, wherein the pipeline passes through a first cladding pipe end of the cladding pipe so that a first pipeline end of the pipeline is rigidly connectible to the outer container and the first cladding pipe is rigidly connectible to the inner tank, wherein the cladding pipe protrudes into the inner tank, wherein the pipeline and the cladding pipe are rigidly connected to one another at a second cladding pipe end, and with the pipeline and the cladding pipe each having a kink in an area between the first cladding pipe end and the second cladding pipe end, wherein the pipeline or the cladding pipe is more flexible across at least one functional section than outside of the functional section.

16. A cryogenic container according to claim 15, wherein the kinks are configured in such a way that a first section of the pipeline or, respectively, the cladding pipe is at an angle of 30° to 150° relative to a second section of the pipeline or, respectively, the cladding pipe.

17. A cryogenic container according to claim 15, wherein the pipeline has a thinner wall thickness across at least one functional section than outside of the functional section or wherein the pipeline comprises a bellows pipe across at least one functional section, with the functional section being located at least partially within the cladding pipe.

18. A cryogenic container according to claim 15, wherein the cladding pipe has a thinner wall thickness across at least one functional section than outside of the functional section or wherein the cladding pipe comprises a bellows pipe across at least one functional section.

19. A cryogenic container according to claim 18, wherein an axial reinforcement is spanned across the functional section.

20. A cryogenic container according to claim 15, wherein the pipeline has a welding sleeve at the first pipeline end for connection to the outer container.

21. A cryogenic container according to claim 15, wherein the cladding pipe has a stiffening ring at the first cladding pipe end for connection to the inner tank.

22. A cryogenic container according to claim 15, wherein the cladding pipe has an end plate at the second cladding pipe end for connection to the inner tank.

23. A cryogenic container according to claim 15, wherein the pipeline is equipped with an internal thread at the first pipeline end.

24. A cryogenic container according to claim 15, wherein the intermediate space between the pipeline and the cladding pipe is configured such that the first pipeline end is movable into the cladding pipe by at least one wall thickness of the outer container for an assembly process.

25. A cryogenic container according to claim 24, wherein the pipe penetration module is connected to the cryogenic container in such a way that the pipe penetration module functions as a thermal siphon when the cryogenic container is in an operating position.

26. A cryogenic container according to claim 24, wherein the pipe penetration module is passed through a jacket of the cryogenic container.

27. A cryogenic container according to claim 19, wherein the axial reinforcement is formed by two stiffening rods running in parallel to the cladding pipe and located on opposite sides of the cladding pipe.
